(19) United States
(12) Patent Application Publication
(10) Pub. No.: US 2002/0087487 A1
(43) Pub. Date: Jul. 4, 2002

(54) System for allowing customers to sefl-select service levels from service providers

(76) Inventor: Sebastian Daniel Hassinger, Blanco, TX (US)

Correspondence Address: Duke W. Yee, Carstens, Yee & Cahoon, LLP, P.O. Box 802334, Dallas, TX, 75380, US

(21) Appl. No.: 09/751,624

(22) Filed: Dec. 29, 2000

(51) Int. Cl. G06G 7/00; G06F 17/00

(52) U.S. Cl. 705/400

(57) ABSTRACT

A method, system, and computer program product for providing services to a customer is provided. In one embodiment, a customer is provided with a user interface that allows that customer to input a set of desired services and a level of service for each of one or more services. From the set of selected services, a service level agreement and a billing profile for a billing program are constructed. As the selected services are provided, data is sent to the billing program so that the customer may be billed for the services that have been provided. The services provided to the customer are monitored to determine whether the level of service selected by the customer is being met and if the level of service is not being met, an adjustment to the customer's bill is made prior to billing the customer.

### BACKGROUND OF THE INVENTION

1. Technical Field

The present invention relates generally to methods of doing business and, more particularly, to monitoring levels of service provided to customers by service providers.

2. Description of Related Art

A large and growing segment of the modern economy is the service industry. The service industry includes such industries as internet providers, telecommunications, and cable and satellite television providers. These service industries generate revenue not from physical products sold to consumers, but from services provided to the consumer. The services are typically provided to consumers under service level agreements. These agreements specify the services that are to be provided, the rate that will be charged to the customer for the services, and the level of service that will be provided.

The continued growth of the service provider industry is dependent upon the formation of dependable service levels with customers. If dependable service levels are not provided by a company, the customer may cease to use the service provided by the company and seek alternative services from competitors. Currently, as discussed above, the service level agreement is the preferred method for defining and monitoring the nature and state of the relationship between the customer and the service provider. However, currently, there is no programmatic method for a service provider to define the parameters of what is offered in a service level agreement and, to provide a customer with a self-selection mechanism for the terms of their particular service level agreement. Furthermore, currently there is no integration between service level agreements, service level monitoring systems, and the provisioning, administration, and billing systems of the service level. Thus, customers are often lost due to a failure of the service provider to meet the expectations of the customer defined in the service level agreement due to this lack of integration.

Therefore, it would be advantageous to have an improved method, system, and computer program product that provides for user selected service level agreement from service provider options, wherein corrections are made to billing and service levels corresponding to provisions in the service level agreement.

### SUMMARY OF THE INVENTION

The present invention provides a method, system, and computer program product for providing services to a customer. In one embodiment, a customer is provided with a user interface that allows that customer to input a set of desired services and a level of service for each of one or more services. From the set of selected services, a service level agreement and a billing profile for a billing program are constructed. As the selected services are provided, data is sent to the billing program so that the customer may be billed for the services that have been provided. The services provided to the customer are monitored to determine whether the level of service selected by the customer is being met and if the level of service is not being met, an adjustment to the customer's bill is made prior to billing the customer.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a diagram of an exemplary service provider administrator interface for creating service options in accordance with the present invention;

FIG. 5 depicts a diagram illustrating exemplary extensible markup language text created from entries to an administrator interface in accordance with the present invention;

FIG. 6 depicts a diagram of an exemplary user interface for allowing a consumer to select service options in accordance with the present invention;

FIG. 7 depicts an XML user selection data file in accordance with the present invention; and

FIG. 8 depicts a flowchart illustrating an exemplary process of creating and monitoring a service level agreement in accordance with the present invention.

### DETAILED DESCRIPTION OF THE PREFERRED EMBODIMENT

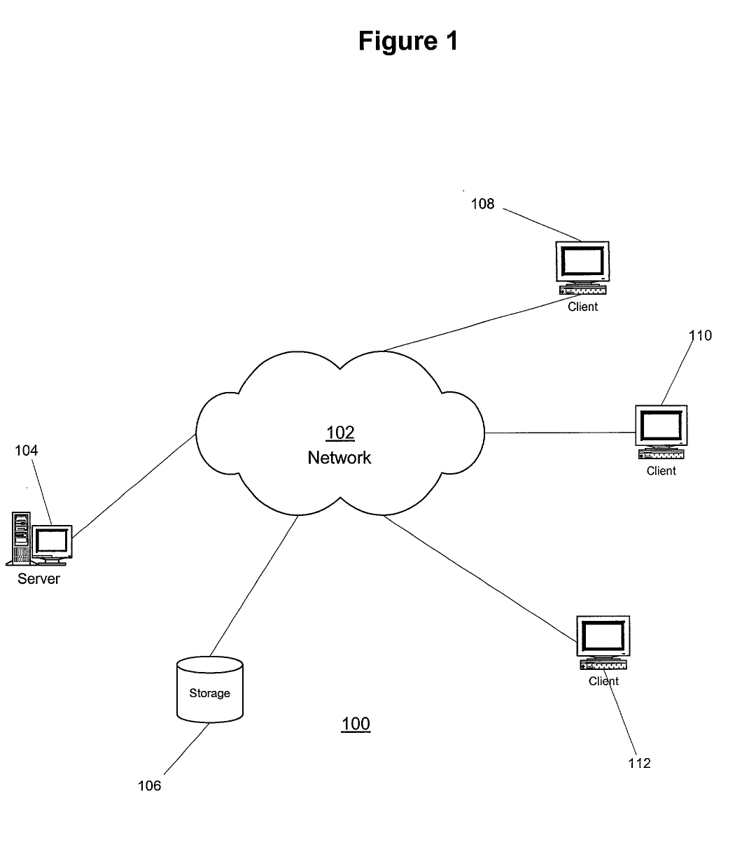

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

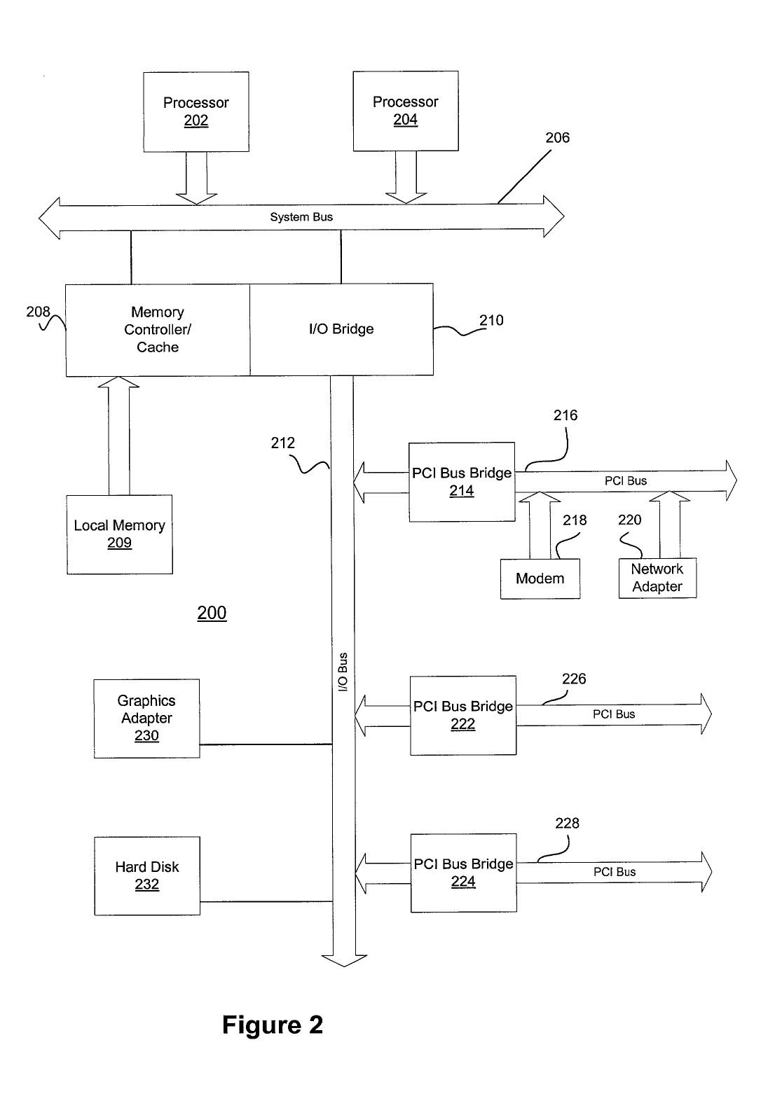

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, New York, running the Advanced Interactive Executive (AIX) operating system.

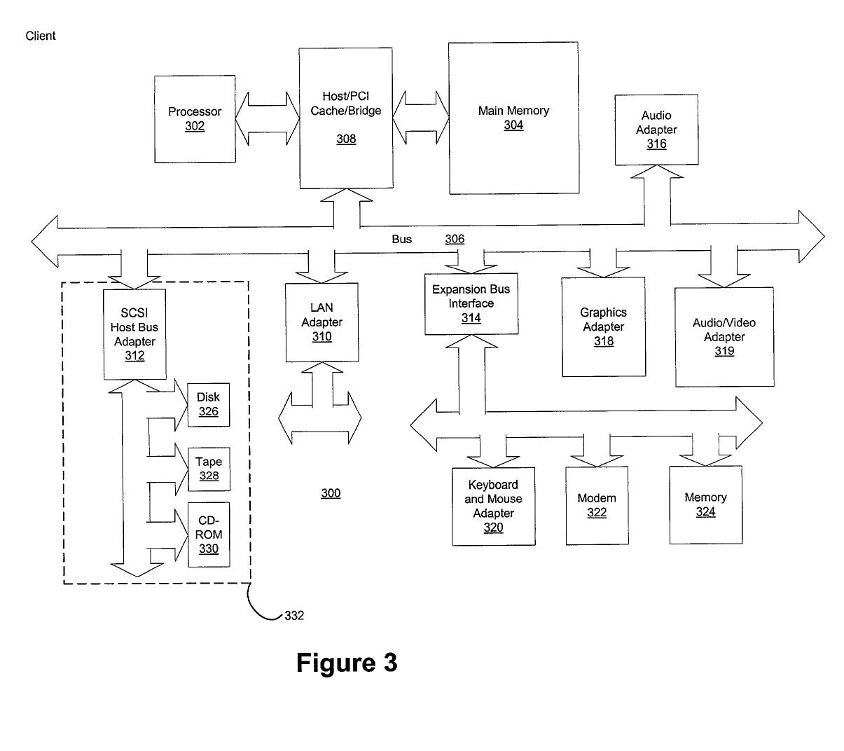

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention allows a service provider, such as, for example, an internet service provider, web host, cable television provider, telephone service provider, or satellite television provider, to define services offered by the provider via an administrator interface. These service options are then available through a network, such as, for example, network 102 in FIG. 1, to users to select service options desired by the user. These service options may be presented to the user via a menu based interface that is generated or populated dynamically using, for example, an XML service definition file. Once the user has selected service options, the service may be monitored and corrections to billing data or other data may be made based on how well the selected service or services were provided.

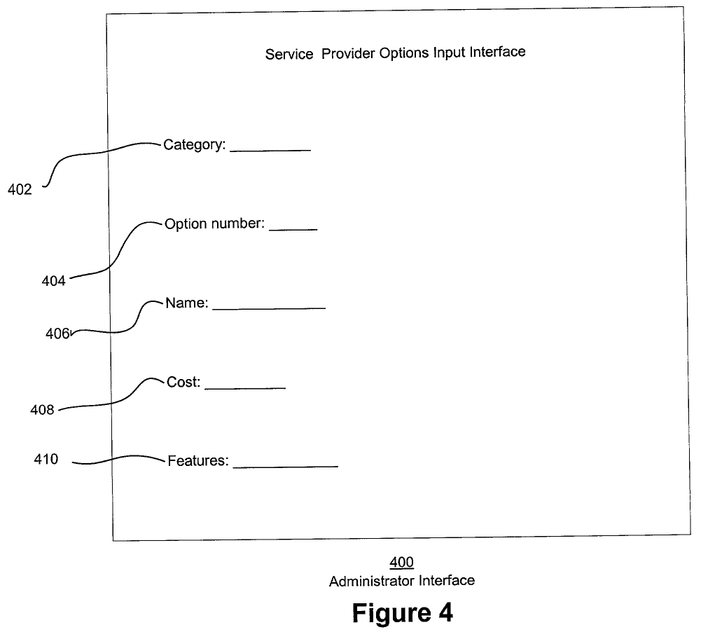

With reference now to FIG. 4, a diagram of an exemplary service provider administrator interface for creating service options is depicted in accordance with the present invention. Administrator interface 400 provides a service provider administrator with a menu based interface with which to input characteristics about a service option that may be presented to a user. Interface 400 may be presented to an administrator on a data processing system, such as, for example, client 108 in FIG. 1.

The administrator interface 400 provides a menu of criteria 402-410 that the administrator should enter to define a service option. In the depicted example, the criteria include a category 402, option number 404, name of the option 406, cost of the service option 408, and other features 410 about the service that would be of interest to a potential customer. Once the service options are entered by the administrator, the service options are stored in a data base, such as, for example, storage 106 in FIG. 1. These service options are then presented to a user, such as, for example, via a web page, when requested by the user.

The administrator interface 400 allows the creation of sub-services that can be optionally added on to top-level services, for example, DNS hosting for a domain in addition to connectivity or web site hosting. The administrator interface 400 also allows for the creation of new data fields and service categories. All data collected from the service provided is stored in a database, for example, in storage 106 in FIG. 1, for example, in an extensible markup language (XML) format. However, other formats may be used as well, such as, for example, hypertext markup language (HTML), wireless markup language (WML), or in a format native to a database platform, such as, for example, Structured Query Language (SQL).

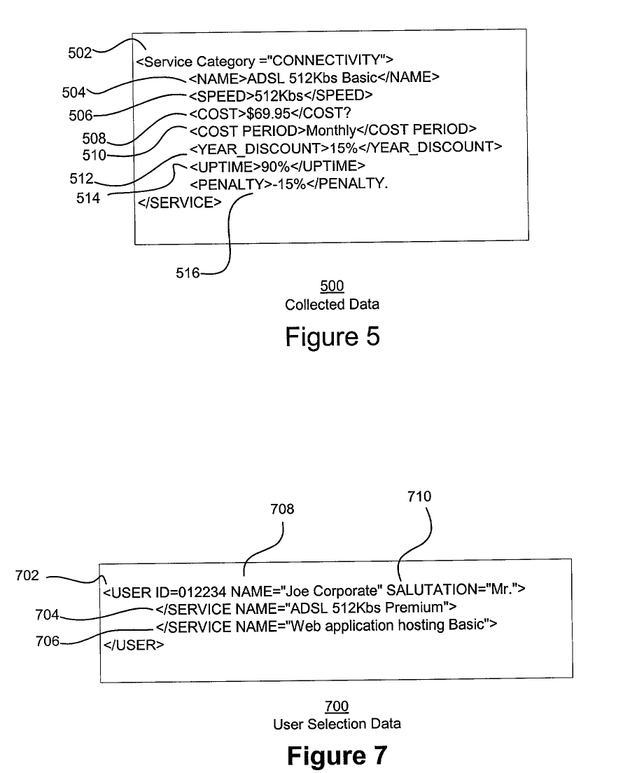

A diagram illustrating an exemplary extensible markup language text created from entries to administrator interface 400 is depicted FIG. 5 in accordance with the present invention. Collected data 500 includes the service category 502, name of the service 504, speed 506, cost 508, cost period 510, discount 512, uptime guaranteed 514, and penalty 516 for failure to meet the guaranteed uptime.

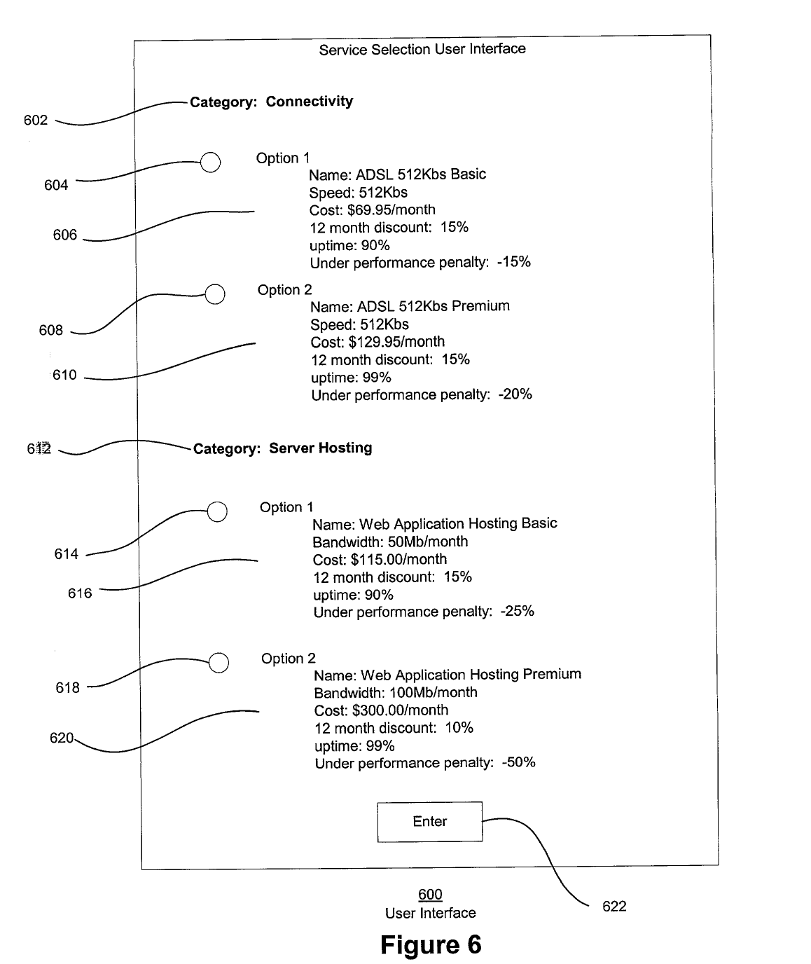

In the present example, service category 502 is “connectivity”, name 504 of the service option is “ADSL 512 Kbs Basic”, cost 506 of the service option is $69.96, and cost period 508 is monthly. Discount 510 for the service option is 15% per year and guaranteed uptime 512 is 90% available. Penalty 514 for failing to meet the guaranteed uptime is −15%. This same data is then used to populate the user's interface as described below in FIG. 6. The penalty discount and the uptime measurement are only one example of the type of metrics that could be available to an administrator while defining a service. The underlying data structures are extensible, so adding new services, measures and types of penalties would be very easy.

The administrator interface depicted in FIG. 4 is an example of a user interface which may be used in accordance with the present invention. However, as one of ordinary skill in the art will recognize, other menu based user interfaces may be used as well. Such other interfaces may include graphical user interfaces or non-graphical user interfaces.

With reference now to FIG. 6, a diagram of an exemplary user interface for allowing a consumer to select service options is depicted in accordance with the present invention. In this example, the service provider provides internet related services, such as internet connectivity and web hosting. Thus, user interface 600 provides a user with two categories of services from which to select: connectivity 602 and server hosting 612. Each category has several options 606, 610, 616, and 620 from which a user may select. Each options 606, 610, 616, and 620 contains a description of the details of the service option 606, 610, 616, and 620, allowing the user to make an informed decision.

For example, service option 1 606 under category connectivity 602 is named ADSL 512 Kbs Basic and has a speed of 512 Kbs. The cost of the service is $69.95 per month with a 12 month discount of 15%. The service agreement, created when this option is selected, calls for an uptime of 90% and an under performance penalty of −15% if the service is up for less than 90% of the time. This under performance penalty allows the user to determine the effect on the price of the service of the provider meeting or failing to meet the selected service level. Each option provides a user with relevant information needed by the user to make an informed choice about whether that particular service option is one that the user would like to purchase. Thus, the user interface 600 menu allows the customer to self-select the terms of the service level agreement based on the customer need and the cost of the service.

The user interface 600 also contains selection indicators 604, 608, 614, and 618 which may be selected, such as by clicking a mouse button when a cursor covers the area of selection indicator 604, 608, 614, and 618, by a user. Once an option or options 606, 610, 616, and 620 have been highlighted by a user, the user may select enter “button” 622 to select the highlighted options. The user may then be presented with a new interface for entering user information such as, for example, billing address, service address, and other relevant information for completing the service level agreement.

In addition to the options described in FIG. 6, user interface 500 may also include features that allow the user to browser through the various service options available from the service provider. For example, the various options may be presented on several “web pages” and the user may be presented with options allowing the user to navigate between the various web pages to view and/or select from the various service options provided.

Once a service option or options have been selected and all customer information entered, the selection produces a file, such as an XML: file such as, for example, the XML user selection data file depicted in FIG. 7 in accordance with the present invention. User selection data 700 in the XML file contains a user ID 702 and name 708 and service names 704-706 of the options selected by the user. In the depicted example, user ID 702 is 012234 and user name 708 is “Joe Corporate” with salutation 710 of “Mr.” In this example, the user has selected two services: service name 704 “ADSL 512 Kbs Premium” and service name 706 “Web application hosting Basic.” The user selection data, such as, for example, user selection data 700, is then sent to or provided to the relevant party within the service provider as a provisioning request. The service level options as contained in the user selection data are also used to set up a monitoring program to monitor the level of service and to set up a billing program to bill the customer at appropriate times for the selected service.

Data collected from the monitoring program, which may provide continuous, periodic, or aperiodic monitoring, is analyzed to determine whether the service provider is meeting or failing to meet the terms of the service level agreement. The policies that affect the final charges or administrative responses are then applied to the monitored data and appropriate actions taken. Thus, if the service provider fails to meet the terms of the service level agreement, the billing program modifies the charge to the customer consistent with the terms of the service level agreement. Also, if the service provider is failing to meet the terms of the service level agreement, various administrators or administrative services are notified in order to correct or remedy whatever condition is causing the service provider to fail to meet the terms of the service level agreement.

The user interface depicted in FIG. 6 is an example of a user interface which may be used in accordance with the present invention. However, as one of ordinary skill in the art will recognize, other menu based user interfaces may be used as well. Such other interfaces may include graphical user interfaces or non-graphical user interfaces.

With reference now to FIG. 8, a flowchart illustrating an exemplary process of creating and monitoring a service level agreement is depicted in accordance with the present invention. Once an administrator's input for various service options are received (step 802), a user interface with the created service level options is generated and presented to a user when requested (step 804). Once service level options are selected by a user and received, a service level agreement, billing profile, and provisioning request are created (step 806).

After the service has been configured, the level of service is monitored and data collected from the monitoring service is provided to the billing program and/or an administrative response unit (step 808). The administrative response unit may be an individual or group of individuals responsible for correcting or modifying the service providers equipment and/or software to bring the service provider into compliance with the terms of the service level agreement. The administrative response unit may alternatively be a software or hardware program capable of remedying the situation automatically.

It is then determined whether the service performance has met or exceeded the service level parameters as defined in the service level agreement (step 810). This determination may be made by the administrative response unit or billing program based upon data received from the monitoring service or may be made by the monitoring service and included as part of the monitored data provided to the administrative response unit and billing program. If the performance has met or exceeded the level of performance defined by the service level agreement, then the customer is billed at the unreduced rate according to the user selected service level agreement and no action is required of the administrative response unit (step 812). If the performance has failed to meet the level defined by the service level agreement, then the customer bill is reduced according to the terms of the service level agreement and/or the administrative response unit takes actions appropriate to bring the level of service back up to the standards prescribed by the service level agreement (step 814). In this step, as discussed above, other types actions in response to other types of measures of standards and penalties could be used in addition to or in place of those discussed herein.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing services to a customer, the method comprising:
providing a customer with a user interface for inputting a set of desired services and a level of service for at least one desired service;
from the set of selected services, constructing service level agreement;
from the set of selected services, constructing a billing profile for a billing program;
as the set of desired services are provided, sending data to the billing program so that the customer may be billed for provided services; and
monitoring the provided services to determine whether the level service is being met.

2. The method as recited in claim 1, wherein an adjustment to the customer's bill is made if the level of service is not met.

3. The method as recited in claim 2, wherein an average level of service for a period is calculated upon which the adjustment is based.

4. The method as recited in claim 1, wherein modifications to a system for providing the services are made to bring the level of service into compliance with defined in the service level agreement.

5. The method as recited in claim 1, wherein the user interface is a menu based interface.

6. The method as recited in claim 1, wherein the user interface is a graphical user interface.

7. The method as recited in claim 1, wherein the user interface is created from data gathered from a service administrator.

8. The method as recited in claim 7, wherein the data gathered from the service administrator is gathered via an administrator interface.

9. The method as recited in claim 1, wherein the user interface is provided via a network.

10. The method as recited in claim 9, wherein the network is the Internet.

11. A computer program product in a computer readable media for use in a data processing system for providing services to a customer, the computer program product comprising:
first instructions for providing a customer with a user interface for inputting a set of desired services and a level of service for at least one desired service;
second instructions, from the set of selected services, for constructing service level agreement;
third instructions, from the set of selected services, for constructing a billing profile for a billing program;
fourth instructions for, as the set of desired services are provided, sending data to the billing program so that the customer may be billed for provided services; and
fifth instructions for monitoring the provided services to determine whether the level service is being met.

12. The computer program product as recited in claim 11, wherein an adjustment to the customer's bill is made if the level of service is not met.

13. The computer program product as recited in claim 12, wherein an average level of service for a period is calculated upon which the adjustment is based.

14. The computer program product as recited in claim 11, wherein modifications to a system for providing the services are made to bring the level of service into compliance with defined in the service level agreement.

15. The computer program product as recited in claim 11, wherein the user interface is a menu based interface.

16. The computer program product as recited in claim 11, wherein the user interface is a graphical user interface.

17. The computer program product as recited in claim 11, wherein the user interface is created from data gathered from a service administrator.

18. The computer program product as recited in claim 17, wherein the data gathered from the service administrator is gathered via an administrator interface.

19. The computer program product as recited in claim 11, wherein the user interface is provided via a network.

20. The computer program product as recited in claim 19, wherein the network is the Internet.

21. A system for providing services to a customer, the system comprising:
first means for providing a customer with a user interface for inputting a set of desired services and a level of service for at least one desired service;
second means, from the set of selected services, for constructing service level agreement;
third means, from the set of selected services, for constructing a billing profile for a billing program;
fourth means for, as the set of desired services are provided, sending data to the billing program so that the customer may be billed for provided services; and
fifth means for monitoring the provided services to determine whether the level service is being met.

22. The system as recited in claim 21, wherein an adjustment to the customer's bill is made if the level of service is not met.

23. The system as recited in claim 22, wherein an average level of service for a period is calculated upon which the adjustment is based.

24. The system as recited in claim 21, wherein modifications to a system for providing the services are made to bring the level of service into compliance with defined in the service level agreement.

25. The system as recited in claim 21, wherein the user interface is a menu based interface.

26. The system as recited in claim 21, wherein the user interface is a graphical user interface.

27. The system as recited in claim 21, wherein the user interface is created from data gathered from a service administrator.

28. The system as recited in claim 27, wherein the data gathered from the service administrator is gathered via an administrator interface.

29. The system as recited in claim 21, wherein the user interface is provided via a network.

30. The system as recited in claim 29, wherein the network is the Internet.
